(19) United States
(12) Patent Application Publication
(10) Pub. No.: US 2025/0058456 A1
(43) Pub. Date: Feb. 20, 2025

(54) MARKING TOOL

(71) Applicant: wolfcraft GmbH, Kempenich (DE)

(72) Inventors: Christopher MOOG, Wirges (DE); Lothar WOICK, Hoenningen (DE)

(73) Assignee: wolfcraft GmbH, Kempenich (DE)

(21) Appl. No.: 18/721,292

(22) PCT Filed: Dec. 20, 2022
(86) PCT No.: PCT/EP2022/086971

§ 371 Date: Jun. 18, 2024

(30) Foreign Application Priority Data
Dec. 20, 2021 (DE) 10 2021 133 883.2

(51) Int. Cl. B25H 7/02; G01B 3/06; G01B 3/56

(52) U.S. Cl. CPC B25H 7/02; G01B 3/06; G01B 3/56

(57) ABSTRACT

A marking triangle includes two partial triangles connected via a joint and in which, when the marking triangle is folded, a cut-out forms contact flanks which, together with a marking edge of the bottom of the recess, allow for a center to be marked on a workpiece. In addition, a solder body of a plumb line can be inserted in the recess.

### FIELD OF TECHNOLOGY

The invention relates to a marking tool. The marking tool has the shape of a triangle and can consist of two partial triangles, which are pivotable about a joint. An angular scale can be arranged on a broadside of the marking tool.

### PRIOR ART

Marking tools are known in many forms from the prior art. For instance, the U.S. Pat. No. 8,074,368 B2 describes a marking angle comprising two identically designed triangles, which are connected to one another on a joint axis. One of the partial triangles can form a stop edge. The US D 445,700 S and the EP 1 601 927 B1 show a marking angle, in the case of which the stop edge lies opposite an angle scale. A marking tool comprising openings is known from the U.S. Pat. No. 3,375,589. A marking tool with a plumb function is known from the U.S. Pat. No. 5,933,974. A marking tool comprising a cut-out, into which an insert is clamped, is known from the U.S. Pat. No. 2,428,699. The U.S. Pat. No. 8,146,260 B1 describes a marking triangle comprising a first partial triangle, which has an opening formed as window, which can be closed by a second partial triangle when the second partial triangle is pivoted from a juxtaposition to the first partial triangle about a pivot axis onto the first partial triangle.

### SUMMARY OF THE INVENTION

The invention is based on the object of increasing the application spectrum of a marking tool in a manner, which is advantageous for its use or to improve the manageability of a marking tool, respectively.

According to a first aspect of the invention, a marking tool formed as marking triangle has a cut-out, which extends in a broadside surface. The rim of the cut-out has two contact flanks, which intersect at a point of intersection. The cut-out can form a recess, which has a bottom. A marking edge, which can be used to mark a center line on a front side of the workpiece, runs through the bottom. The contact flanks run symmetrically to the marking edge. The marking edge can run through a point of intersection of the contact flanks. The contact flanks can extend along straight lines intersecting in the point of intersection. If a circular cylindrical workpiece is applied with its circumferential rim against the contact flanks, so that the front side of the workpiece lies on the bottom, the marking edge runs through the center point of the cylinder. In a first rotational orientation of the workpiece, a center line can be drawn by means of a pencil along the marking edge over the front side. After a rotation of the workpiece, a second center line can be drawn over the front side. The point of intersection of the two center lines then lies in the center point of the front side. According to a preferred use of the marking tool, three center lines on the front side are drawn in three different rotational positions of the workpiece, which are angularly offset approximately by 120 degrees, so that the three lines either intersect in one point or represent a small triangle, which has the center point of the front side of the workpiece in its center. The center point of the front surface of a workpiece, which has a square cross section, can be determined analogously, in particular when the contact flanks preferably extend in a straight line and are preferably at right angles to one another. The marking edge is preferably formed by a window in the bottom of the recess, so that the pencil can be placed from the other broadside surface of the marking tool. In a further development of the invention, it is provided that the recess is created by the interaction of two partial triangles, which are connected to one another by means of a joint. The two partial triangles can be brought from a juxtaposition, in which the partial triangles lie essentially in a common plane, into an overlapped position. The bottom of the recess is preferably formed by one of the two partial triangles, and the cut-out by another one of the two partial triangles. If the two partial triangles are brought into an overlapped position, one of the broadside surfaces of the partial triangle forms the bottom, which has the window and the marking edge. The contact flanks are formed by the other partial triangle. The bottom, however, can also be formed by a recessed section of a broadside surface of the partial triangle. It can also be provided, however, that the marking tool is formed in one piece.

The marking triangle has two partial triangles, which can be brought about a joint axis from a juxtaposition, in which the two partial triangles lie in a common plane, into an overlapped position. The joint can form joint rollers, through which a joint axis extends. Joint rollers of the one partial triangle can alternately lie in the axial direction next to joint rollers of the other partial triangle. The joint rollers can thereby protrude beyond a first one of the two broadside surfaces of the partial triangles. According to the invention, spacer elements are provided, which protrude from the first broadside surface of one of the two partial triangles. The other partial triangle can have recesses, with which the spacer elements of the one partial triangle can engage when the two partial triangles lie one on top of the other. According to a preferred design, it is provided that both partial triangles have spacer elements and recesses on their respective first broadside surfaces, which lie one on top of the other in the overlapped position, so that the spacer elements of the one partial triangle can engage with the recesses of the other partial triangle, and the first broadside surfaces lie flat one on top of the other when lying one on top of the other. The dimension by which a spacer element protrudes from the broadside surface can correspond to the dimension by which the joint roller protrudes from the broadside surface. However, the dimension by which a spacer element protrudes from the broadside surface is preferably slightly smaller than the dimension by which the joint roller protrudes from the broadside surface. If a marking tool of this type is applied to a workpiece, which has two surfaces abutting against one another at an angle, in particular right angle, wherein a partial triangle is in each case placed onto one of the two surfaces, the joint of the marking tool extends parallel and adjacently along the edge. Due to the fact that an edge of this type, for example in the case of a square timber, has a slight rounding or bezel, all spacer elements can support themselves on the surface of the workpiece, even if their dimension of protrusion beyond the broadside surface is slightly smaller than the dimension of protrusion of the joint roller. The recesses, which can be used to receive the spacer element, can have a bottom. The layout of the recesses essentially corresponds to the layout of the spacer elements entering therein. It can be a circular layout. However, the layout can also run in an elongated manner. The spacer element can thus not only be formed circular cylindrically but can also have the shape of a rib.

The invention furthermore relates to a marking tool, which can have the above-mentioned features. The marking tool has a yoke, which is formed, for example, by a notch or a bore. The string of a plumb bob can be placed over this yoke, which is preferably arranged in a corner region of the marking tool. The yoke can be arranged in the region of a corner of the marking tool. It is provided in particular that the yoke is arranged so as to directly adjoin a corner of the marking tool and is open towards an edge of the marking tool, which is manufactured as flat piece. A straight outer edge of the marking tool can lie opposite the corner. One of the broadside surfaces of the marking tool has a first angle scale, which extends around the yoke, so that one of the outer edges of the marking tool can be applied to a surface, for example of a structure or workpiece. The string, on which a plumb body is located, then defines a vertical direction. An angle of inclination of the surface can be measured via the angle scale. According to the invention, it is provided that the marking tool has a receiving means, in which the plumb bob and in particular the plumb body of the plumb bob can be stored in a storage position. The receiving means can have a recess. The recess can be formed by a cut-out. The marking tool can consist of two partial triangles, which are connected to one another by means of a joint. One of the two partial triangles can have a window, which forms a cut-out. When the two partial triangles lie one on top of the other, the cut-out forms the rim of a recess. The other partial triangle can form the bottom of the recess. Fixing means are provided, by means of which the plumb body can be fixed within the recess, so that it cannot fall out of its storage position. It can be provided that a latching force has to be overcome in order to remove the plumb body from its storage position. The bottom of the recess can have a fixing opening, with which a fixing protrusion of the plumb body can engage. The plumb body preferably has two restraining protrusions, which can each engage with a restraining opening. The restraining means can be protrusions, which engage with recesses. The protrusions can be latching protrusions, which engage with the recesses in a latching manner. The protrusions can have hook-like appendages, which can engage behind a rim of the recess area by area. The plumb body can be a flat piece. The receiving means for receiving the plumb body can be a recess. The recess can be the same recess, which, according to the above-described first aspect of the invention, can be used to find the center point. According to a preferred design, the plumb body has two indentations lying opposite one another, which each have bottom edges. The string of the plumb bob can be wound up around the two bottom edges of the indentation. The region of the plumb body, which extends between the two bottom edges, can have a decreased material thickness, so that the wound-up string is not bulky. The material thickness of the plumb body can correspond to the depth of the recess. If the marking tool consists of two parts, which are connected to one another in an articulated manner, the material thickness of the plumb body corresponds to that of the partial triangle, which forms the cut-out. Instead of a plumb body, however, any random object, for example a screw or a rotationally symmetrical plumb body, can also be used. The above-described plumb body can then have the function of a winding body, around which the string is wound up. The winding body can be inserted in the recess with wound-up string. A certain length of the string can be unwound from the winding body. The string can be placed over the yoke. A weight can be fastened to the free end of the string. With winding body lying in the recess, the marking tool can be used as plumb.

The marking tool, as it is described above, can have two partial triangles, which can be pivoted one on top of the other and which are each right-angled triangles. In the juxtaposition, these partial triangles then form two equally long cathetus sides and a hypotenuse side. The joint extends perpendicular to the hypotenuse side and through the point of intersection of two straight lines, which are defined by the cathetus sides. If the two partial triangles are placed one on top of the other, the two hypotenuses of the partial triangles lie one on top of the other. A cathetus of the partial triangle can form a stop strip. The stop strip can protrude from the partial triangle in the direction of a second broadside surface. However, the stop strip can also protrude from the first broadside surface, which abuts against the first broadside surface of the other partial triangle when the partial triangles lie one on top of the other. The stop strip can thus extend over approximately one half of the hypotenuse side of the triangular marking tool, when the two partial triangles assume their juxtaposition. An edge of the stop strip facing the joint can form a center of a second angle scale. The stop strip cannot extend all the way to a joint axis of a joint, by means of which the two partial triangles are connected to one another. With one edge, it can have a small distance from the joint axis. The side of the stop strip facing the surface of the partial triangle forms a stop side, which can be formed by ribs. The apex lines of the ribs thus define a surface, which, in turn, can define a zero line. The broadside surface of the partial triangle can have a plurality of openings, which, in interaction with the apex lines of the ribs or of the stop side of the stop strip, respectively, can be used as marking gauge. The stop strip furthermore defines a stop edge, which can be applied to an edge surface of a workpiece, in order to draw a line on another surface of the workpiece. It can be provided that the partial triangle, which does not form the stop strip, has longitudinal slits. These longitudinal slits can be arranged one behind the other in such a way that they lie on a line. This line is preferably aligned with the zero line. It can be provided thereby that a longitudinal center line of the longitudinal slits is aligned with the zero line. It can also be provided, however, that a straight-lined outer edge of the longitudinal slits is aligned with the zero line. The stop strip preferably protrudes only to one of the two broadside surfaces. It is preferably the broadside surface, which lies opposite the broadside surface, which has the above-mentioned spacer elements. The stop strip can be placed with the stop surface, which extends transversely to the broadside surface, against an outer edge of a workpiece. The marking tool can be rotated around the center of the edge forming the center of the second angle scale, in order to mark lines on a side surface of the workpiece, which have an angle to the outer edge of the workpiece, which can be read on the second angle scale. In a further development of the invention, it is provided that the marking tool has a center point opening. This center point opening serves the purpose of using the marking tool as compass. The center point opening defines the center point of a circle, which can be drawn with the help of the marking tool. The center point opening can lie on the zero line, so that the openings, which are also used when using the tool as marking gauge, can be used to draw a circle around the center point opening. The marking tool is thereby rotatably fastened to the workpiece by means of a nail or the like, which engages through the center point opening. However, other radial distance openings can also be provided, which are spaced apart from one another in particular by a multiple of a basic value and from the center point opening. The above-described yoke can be adjacent to the edge of the stop strip, can thus be arranged approximately in the center of the hypothenuse side close to the joint.

### BRIEF DESCRIPTION OF THE DRAWINGS

The invention will be described in more detail below on the basis of enclosed drawings on the basis of exemplary embodiments and application examples, in which:

FIG. 1 shows a first exemplary embodiment of a marking tool, which consists of two partial triangles 9, 9′, which lie in a juxtaposition, in a perspective illustration,

FIG. 2 shows a top view onto the first exemplary embodiment with juxtaposed partial triangles 9, 9′,

FIG. 2a shows the section according to the line IIa-IIa in FIG. 2,

FIG. 3 shows the two partial triangles 9, 9′ when lying one on top of the other, in perspective illustration,

FIG. 4 shows the two partial triangles 9, 9′ lying one on top of the other in a top view,

FIG. 4a shows the section according to the line IVa-IVa in FIG. 4,

FIG. 5 shows an application example, in the case of which a line, the angle of which can be read on an angle scale 25, is drawn on a surface 32′ of a workpiece 32 by means of a pencil 31 along an outer edge of a longitudinal slit 38, wherein an outer edge 24 of a stop strip 23 supports itself on an edge surface of the workpiece 32,

FIG. 6 shows a further application example, in the case of which a stop side 23′ of the stop strip 23 supports itself on an edge surface of a workpiece 32 and, by shifting the marking tool 1, a line is drawn parallel to the edge of the workpiece 32 by means of a pencil 31, the tip of which protrudes into an opening 26,

FIG. 7 shows a further application example, in the case of which the marking tool 1 is fastened to a workpiece 32 by means of a non-illustrated pin, which engages through a center point opening 30, so that by rotating the marking tool 1 around the center point opening 30, a circle is drawn around the pin on the surface 32′ by means of a pencil 31, the tip of which engages with an opening 26,

FIG. 8 shows a further application example, in the case of which the front side 5′ of a circular cylindrical workpiece 5 is placed onto the bottom 6 of a recess formed by a cut-out 2, and the jacket surface 5″ of the workpiece 5 abut against contact flanks 3, so that a marking edge 7′ of a window 7 in the bottom 6 runs through a center line of the front side 5′,

FIG. 9 shows the application example illustrated in FIG. 8, whereby a center line is drawn along the marking edge 7′,

FIG. 10 shows a further application example, in the case of which an outer edge of the marking tool is placed against a surface 32′, for example of a stationary workpiece 32, and the angle of the surface 32′ to the vertical can be read on an angle scale 19 by means of a string 16 of a plumb bob, which has a plumb body 17,

FIG. 10a shows an illustration similar to FIG. 10, but whereby the plumb body 17 is used only as winding body and is inserted with partially angled string 16 in the cut-out 2, wherein the string 16 is guided over the yoke 15. A weight is fastened to the free end of the string 16, which hangs downwards, as plumb body,

FIG. 11 shows a further application example, in the case of which a partial triangle 9 is placed onto a surface 32′ of a square timber 32 and a further partial triangle 9′ on a surface 32″ extending at a right angle thereto, and a line extending at a right angle to the edge of the workpiece 32 is drawn by means of a pencil 31,

FIG. 12 shows the application example illustrated in FIG. 11 in an enlarged manner and in a different perspective for clarifying the effect of spacer elements 13, which protrude from a first broadside surface 10, 10′ of the partial triangles 9, 9′ and support themselves on the surfaces 32′, 32″,

FIG. 13 shows a further application example, in the case of which the two partial triangles 9, 9′ are in a juxtaposition and a joint roller 8′ support itself on a surface 32′ of the workpiece 32 and the spacer elements 13 directly adjacent to the joint roller 8′ have a slight distance from the surface 32′ of the workpiece,

FIG. 14 shows a second exemplary embodiment of the invention in an illustration according to FIG. 1.

### DESCRIPTION OF THE EMBODIMENTS

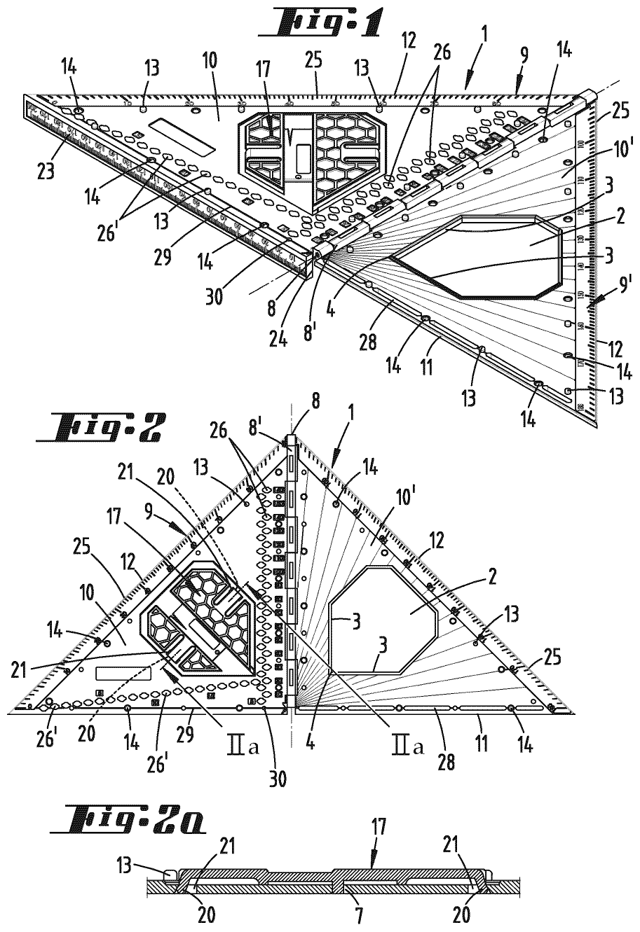

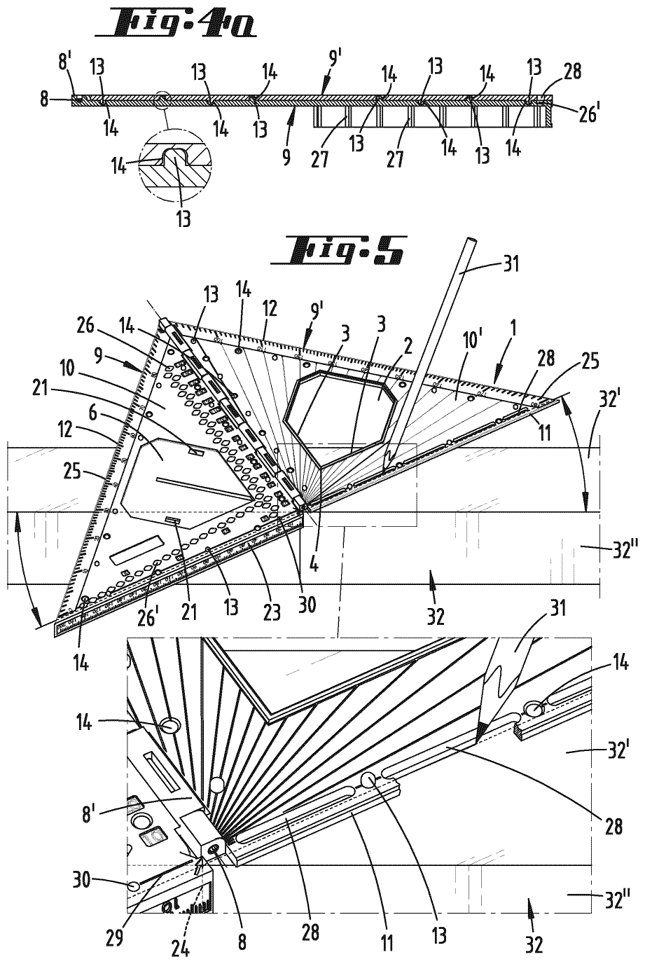

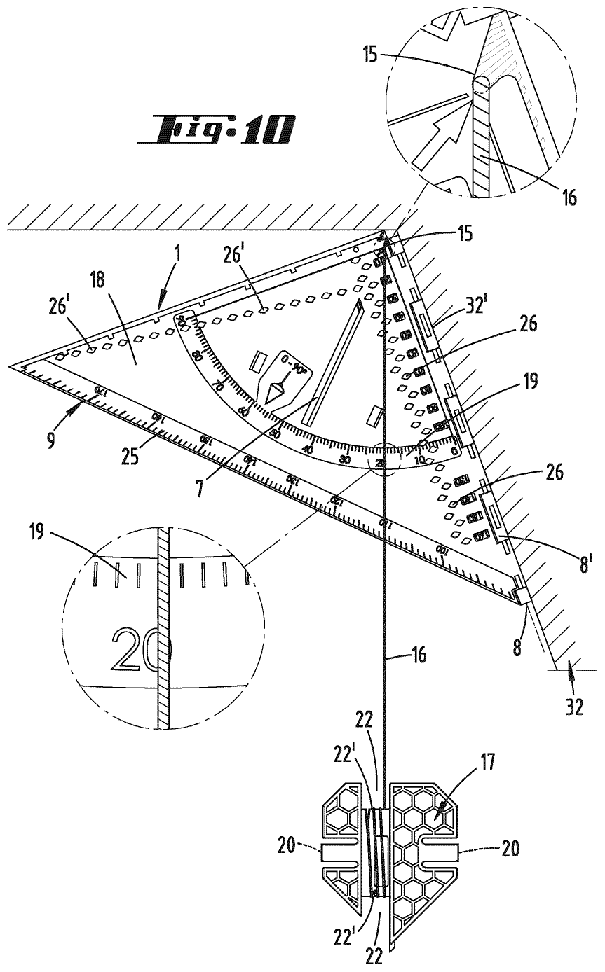

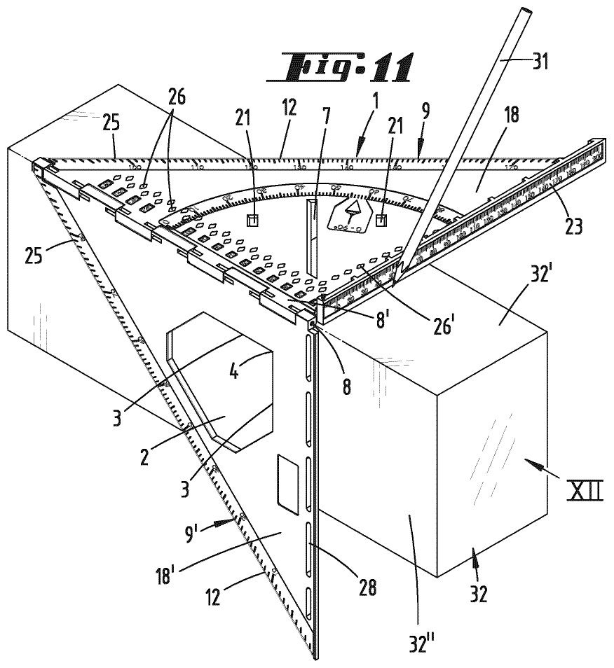

The tool illustrated in FIGS. 1 to 13 is a marking tool 1 in the form of a marking triangle. The marking triangle has a first partial triangle 9 and a second partial triangle 9′. The two partial triangles 9, 9′ are pivotably connected to one another by means of a joint 8. In a juxtaposition of the two partial triangles 9, 9′ illustrated in FIG. 1, the hypothenuses of the respective partial triangles 9, 9′ form cathetus sides 12 of the marking triangle 1. Two catheti of the two partial triangles 9, 9′ are connected to one another by means of a joint 8. The joint 8 has a joint axis, which engage through joint rollers 8′, which alternately engage with one another and which are each assigned to one of the two partial triangles 9, 9′. Together, two catheti of the partial triangles 9, 9′ form a hypotenuse side 11 of the marking triangle. The two partial triangles 9, 9′ are made of flat plastic parts and are essentially of equal size, so that, when lying one on top of the other, the two partial triangles 9, 9′, which can be reached by means of a pivoting displacement of the partial triangle 9′ from the position illustrated in FIG. 1 into the position illustrated in FIG. 3 by 180 degrees, lie one on top of the other congruently. The two outer edges of the partial triangles 9, 9′ previously formed by the cathetus side 12 then form the hypotenuse of an isosceles right-angled triangle.

A cathetus of the partial triangle 9 is connected integrally to a strop strip 23, which extends essentially over the entire length of the cathetus of the partial triangle 9. An edge of the stop strip 29 facing the joint forms a stop edge 24, with which the marking triangle can be placed against a surface 32″ of a workpiece 32, which merges into a surface 32′, which is at a right angle thereto, by forming an edge, for example in the application case illustrated in FIG. 5. An angle, which can be read on an angle scale 25, can be marked on said surface by means of a pencil 31, whereby the angle scale 25 is assigned to the partial triangle 9, which also forms the stop strip 23.

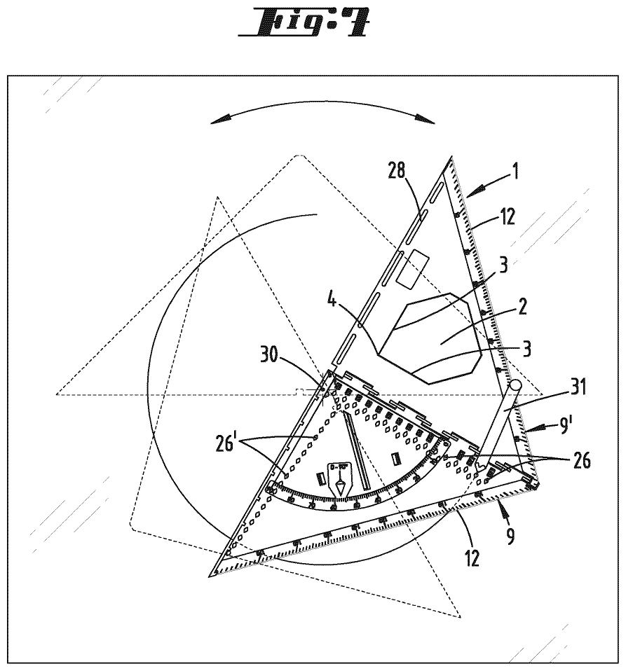

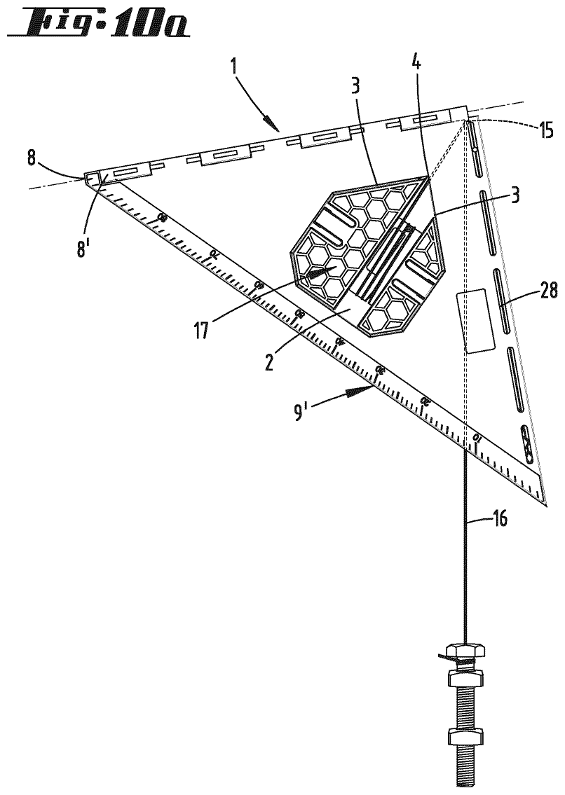

The stop strip 23 has a visible side, which is provided with a scale. The side facing away from the visible side forms a stop side 23′, which can be placed against a surface 32″ of a workpiece 32, as shown in FIG. 6. The stop side 23′ has ribs 27 running transversely to its extension (see FIG. 9), which can be brought to rest against the surface 32″ of the workpiece 32. The partial triangle 9 forming the stop strip 23 additionally has openings 26, which have a drop shape. The tip of a pencil 31 can be inserted into the openings, in order to use the marking triangle 1 as marking gauge, as it is shown in FIG. 6. The openings 26 are spaced apart with a multiple of 5 mm from a zero line defined by the apexes of the ribs 27. The exemplary embodiments illustrated in FIGS. 1 and 14 additionally have openings 26′, which are spaced apart with a multiple of 1 mm from the apex lines of the ribs 27. These openings can also be used as marking gauge when using the marking triangle 1.

Along its cathetus forming the hypothenuse side 11, the other partial triangle 9′ additionally has longitudinal slits 28, which are windows open on both sides, through which the tip of a pencil 31 can be pushed in order to draw a line, which is aligned with the zero line.

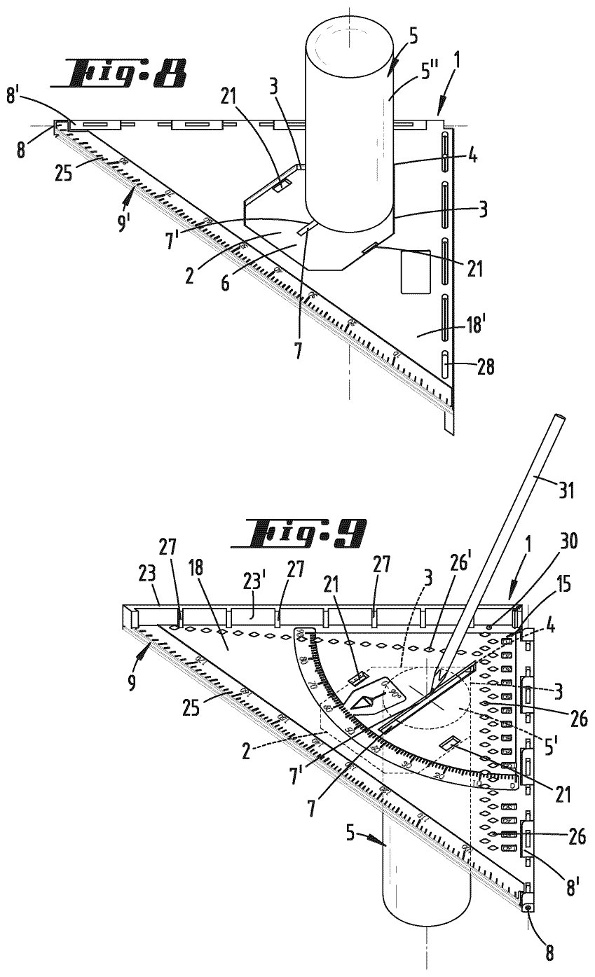

A center point opening 30 is located in the zero line. The marking tool I can be used as compass (see FIG. 7) with the help of the center point opening and the openings 26. The marking tool 1 is fastened to a surface 32′ of a workpiece 32 by means of a pin, for example a nail, which engages through the center point opening 30. The tip of a pencil can then be inserted into one of the openings 26. In that the marking tool 1 is then rotated around the center point opening 30, a circle can be drawn around the pin.

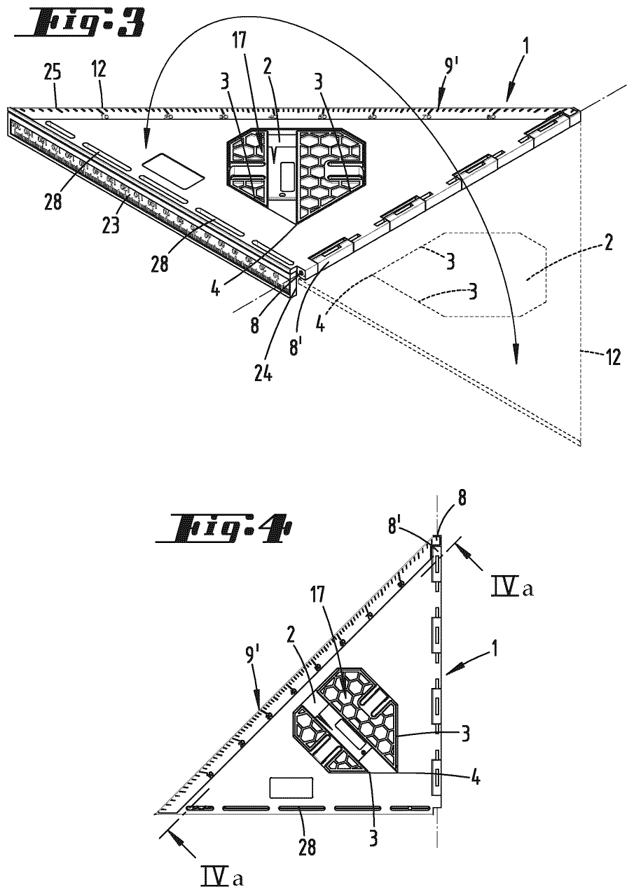

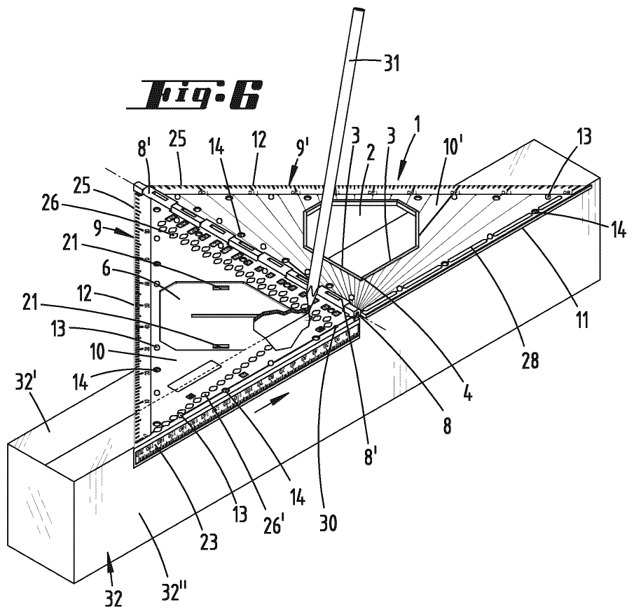

The FIGS. 1 and 2 show the marking triangle 1 with unfolded partial triangles 9, 9′, which lie in a juxtaposition. The partial triangle 9′ forms a cut-out 2 with a window, which is open towards both broadside surfaces of the partial triangle 9′. The cut-out 2 has two contact flanks 3, which intersect in a point of intersection. In the case of the exemplary embodiment, the contact flanks 3 have an angle of 90 degrees to one another. In other, non-illustrated exemplary embodiments, this angle can be larger or smaller, however. The two partial triangles 9, 9′ form first broadside surfaces 10, 10′, which lie flat one on top of the other when lying one on top of the other. In the configurations illustrated in FIGS. 3 and 4, in which the partial triangles 9, 9′ lie one on top of the other, the rims of the cut-out 2 limit a surface section of the first broadside surface 10 of the partial triangle 9. A plumb body 17, which is connected to the partial triangle 9 with the help of latching means, is located on this surface section.

The plumb body 17 is removed in the illustrations of FIGS. 5, 8 and 9. The surface section of the first broadside surface 10 of the partial triangle 9 limited by the cut-out 2 forms the bottom 6 of a recess, the rim of which in particular forms the two contact flanks 3. A marking edge 7′, which runs through the point of intersection of the two contact flanks 3, extends in the bottom 6 of the recess. In the case of the exemplary embodiment, the marking edge 7′ is formed by the rim of an elongated window 7 in the partial triangle 9. The FIG. 9 demonstrates how a center line can be drawn with the help of the tip of a pencil 31 along the marking edge 7′ onto a front side 5′ of a cylindrical workpiece 5. For this purpose, the jacket surface 5″ of the workpiece is placed against the contact flanks 3. Two or more center lines can be applied to the front side 5′ by means of a rotation of the workpiece 5. The crossing point of the center lines then characterized the axial center of the workpiece 5.

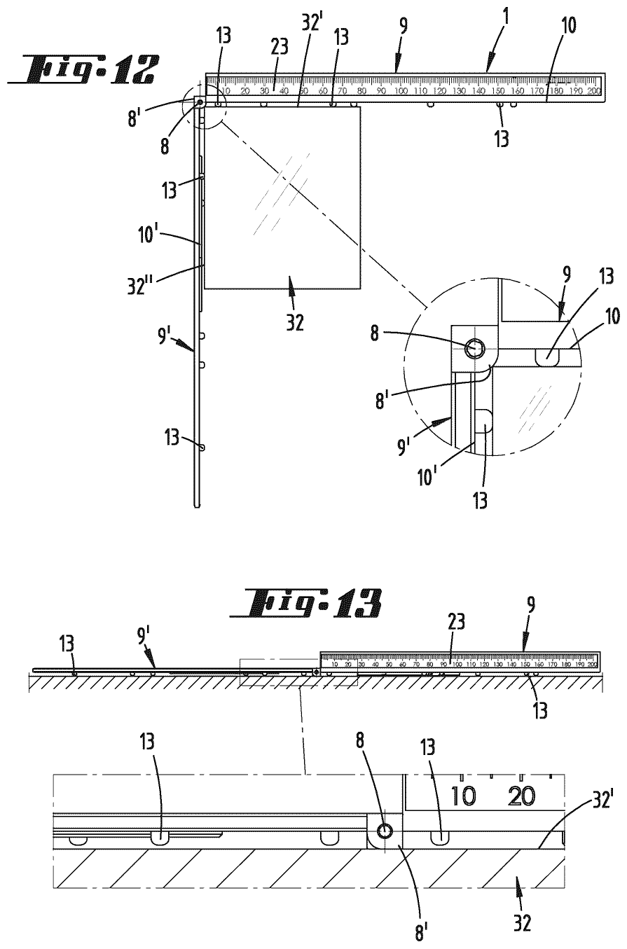

In the case of the exemplary embodiment illustrated in FIG. 12, the two partial triangles 9, 9′ have an angle of 90 degrees to one another. A workpiece comprising two surfaces 32′, 32″, which are at a right angle to one another, for example a square timber, is illustrated with reference numeral 32 here. The partial triangle 9 abuts against the surface 32′ and the partial triangle 9′ against the surface 32″. The joint 8 is located in the region of the edge of the workpiece 32, on which the two surfaces 32′ and 32″ abut against one another. The joint roller 8′ protrudes beyond the first broadside surface 9, 9′. In the use case illustrated in FIG. 12, it lies on the edge of the workpiece, which usually rounded or has a bevel.

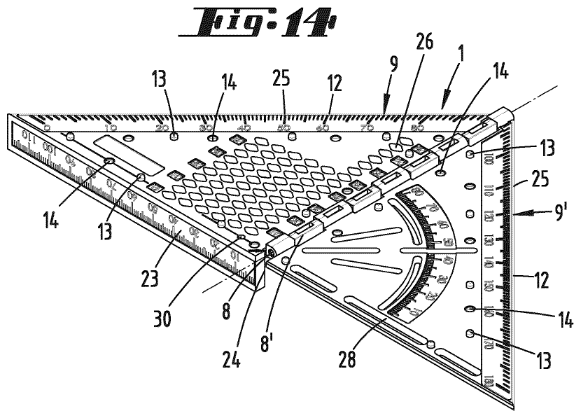

Protrusions, which form spacer elements 13, which have an essentially circular cross section, protrude from the broadside surfaces 10, 10′. These spacer elements 13 support themselves on the surfaces 32′ and 32″, so that the two partial triangles 9, 9′ have a 90 degree angle to one another in spite of the protruding joint rollers 8′. Due to the above-mentioned rounding or chamfer of the edge of the workpiece 32, the height of the spacer elements 13, with which a front surface of the spacer element 13 is spaced apart from the broadside surface 10, 10′, does not need to have the full height of the joint roller 8′. The FIG. 13 shows that, for this reason, the spacer elements 13 adjacent to the joint 8 are spaced apart from a surface 32′ of the workpiece 32, when the marking tool 1 is placed onto a surface 32′ in the juxtaposition of the partial triangles 9, 9′.

Each of the two first broadside surfaces 10, 10′ has recesses 14, into which the spacer elements 13 can dip in the overlapped position of the two partial triangles 9, 9′. The recesses 14 are formed as blind holes and can have a cross section, which is only slightly larger than the cross section of the spacer elements 13, but otherwise corresponds to the cross sectional shape of the spacer elements 13. The depth of the recesses 14 can be slightly larger than the height of the spacer elements 13.

In the case of the exemplary embodiment illustrated in FIG. 14, spacer elements 13 can furthermore also dip into longitudinal slits 28.

The plumb body 17 is formed by a flat plastic part, which has essentially the same material thickness as the partial triangle 9′, in the cut-out of which the plumb body 17 can be stored. With regard to the use of the plumb body 17, reference is made to FIG. 10. Approximately in the center of the hypothenuse side 11, one of the partial triangles 9, 9′, in the exemplary embodiment the partial triangle 9, has a notch, which forms a yoke 15, via which the string 16 of a plumb bob can be placed with the plumb body 17. An angle scale 19, the center point of which is the yoke 15, is located on a second broadside surface 18 of the partial triangle 9. An angle of inclination of a surface 32′ of a stationary workpiece, such as, for example, of a housing wall or of a building wall, can be determined by means of this angle scale 19.

The plumb body 17 has a contour, which allows for an insertion of the plumb body 17 into the cut-out 2. The plumb body 17 has two hook-like wings, which face away from one another, which, with their free ends, form restraining protrusions 20, which can engage with restraining openings 21 of the partial triangle 9, wherein the restraining openings 20 are arranged in the region of the surface section of the broadside surface 10, which form the bottom 6 of the depression. The plumb body 17 can additionally have a rib, which can engage with the window 7.

The FIG. 10 shows the use of the plumb body 17 as weight on a plumb bob. The FIG. 10a shows the use of the plumb body 17 as winding body, which is inserted in the cut-out 2 with partially unwound string 16, wherein another weight, with which the device is used as plumb, is fastened to the free end of the string.

The plumb body 17 additionally has two indentations 22, which face away from one another and which each have a bottom edge 22′. The material thickness of the plumb body 17 formed as flat piece is reduced between the bottom edges 22′, so that the string 16 can be wound over this region and over the bottom edges 22′ of the indentations 22. One of the bottom edges 22′ can additionally have a clamping slit, which tapers at an acute angle, into which the end of the string can be clamped.

The above statements serve to describe the inventions, which are captured as a whole by the application and which further develop the prior art at least by means of the following feature combinations, in each case also independently, whereby two, several or all of these feature combinations can also be combined, namely:

A marking tool 1 formed as marking triangle, comprising a cut-out 2 extending in a broadside surface, the rim of which defines two lines intersecting in a point of intersection 4 and forms contact flanks 3 for contacting a circumferential rim of the workpiece 5 adjoining a front surface of a workpiece, wherein a bottom 6 of the cut-out 2 has a window 7, which forms a marking edge 7′ running through an axis of symmetry of the contact flanks 3, along which a center line can be marked on the front surface of the workpiece 5 from the other broadside surface.

A marking tool, which is characterized in that the surface of the marking triangle is divided by a joint 8 into at least two partial triangles 9, 9′, which can be pivoted from a juxtaposition, in which the partial triangles 9, 9′ lie in a common plane, into an overlapped position, in which a first broadside surface 10, 10′ of the two partial triangles 9, 9′ lie on top of one another, wherein the cut-out 2 is formed by one of the partial triangles 9, 9′ and the bottom 6 of the cut-out 2 as well as the marking edge 7′ are formed by another one of the partial triangles 9, 9′.

A marking tool, which is characterized in that the two partial triangles 9, 9′, which can be pivoted one on top of the other, are identically designed right-angled triangles, which, in the juxtaposition, form a triangle with two cathetus sides 12 of equal lengths, a hypotenuse side 11 and a joint 8, which runs perpendicular to the hypotenuse side 11 and through a point of intersection, of the straight line defined by the two cathetus sides 12.

A marking tool, which is characterized in that the contact flanks 3 run in a straight line and/or that the window 7 has an elongated shape and forms the marking edge 7′ with a straight-lined outer edge.

A marking tool, which is characterized in that spacer elements 13, which, in the overlapped position, dip into cut-outs 14 of the first broadside surface of the respective other partial triangle 9, 9′, protrude from the first broadside surface 10, 10′ of each of the two partial triangles 9, 9′.

A marking tool, which is characterized in that the spacer elements 13 have a circular or elongated layout, and the surface extension of the cut-outs 14 correspond to the layout shape of the spacer elements 13 and/or that the height of the spacer elements 13 and the depth of the cut-out 14 is smaller than the material thickness of the partial triangle 9, 9′ and/or that the dimension by which the spacer element 13 protrudes from the broadside surface 10, 10′ is smaller than the dimension by which the joint roller 8′ protrudes from the broadside surface 10, 10′ or that the dimensions are identical.

A multi-edge marking tool, which is characterized by a receiving means for receiving the plumb body 17 of the plumb bob.

A marking tool, which is characterized in that the broadside surface of the marking tool is the surface of a right-angled, in particular isosceles triangle, and the yoke 15 is formed by a notch in the region of the corner lying opposite the hypothenuse.

A marking tool, which is characterized in that the broadside surface 18 has a cut-out 2, in which a winding or plumb body 17, which is formed as flat body, of a plumb bob is accommodated, wherein the material thickness of the winding or plumb body 17 approximately corresponds to the depth of the cut-out 2.

A marking tool, which is characterized in that the broadside surface 18, 18′ is formed by a partial triangle 9′ of a marking triangle 1, in the case of which two partial triangles 9, 9′ of equal size can be pivoted from a juxtaposition, in which the two partial triangles lie in a common plane, into an overlapped position, in first broadside surfaces 10, 10′ of the two partial triangles lie on top of one another, wherein one of the two partial triangles 9, 9′ forms the yoke 15 and the first angle scale 19, and an opening in particular of the other partial triangle 9, 9′ forms the cut-out 2 receiving the plumb body 17.

A marking tool, which is characterized in that the plumb body 17 is held on a bottom of a depression formed by the cut-out 2 by means of at least one fixing protrusion 21 engaging with a fixing opening 20 and/or that the bottom of the cut-out 2 has one or several fixing openings 20, with which a fixing protrusion 21 of the plumb body 17 engages.

A marking tool, which is characterized in that the plumb body 17 has two indentations 22 lying opposite one another and the region between the bottom edges 22′ of the indentations 22 has a reduced material thickness, so that the string 16 of the plumb bob can be wound up around the bottom edges 22′.

A marking tool, which is characterized in that at least one outer edge of a partial triangle 9′, exactly one outer edge of the partial triangle 9′ or an outer edge of the partial triangle 9′ belonging to the hypotenuse side 11 has a stop side 23 protruding beyond the broadside surface 18 with a stop side 23′ extending transversely to the broadside surface 18, wherein an edge 24, which faces the joint 8, of the stop side 23 protruding beyond one of the broadside surfaces 18 is a center of a second angle scale 25 and/or wherein the stop side 23′ forms a zero line 29 for a plurality of openings 26, which are arranged in the broadside and which can be used as marking gauge and/or wherein a partial triangle 9 forming the stop side 23 adjacent partial triangle 9′ form longitudinal slits 28 running along an outer edge, which each have an outer edge, wherein the outer edge or a center line running between two outer edges can be aligned with a zero line 29 defined by the stop side 23′.

A marking tool, which is characterized by a center point opening 30, from which a plurality of radial distance openings 26 are in each case spaced apart by a multiple of a basic value, so that the marking tool can be used as compass and/or that a center point opening 30 is provided in the region of a stop side 23′ of a stop strip 23 and lies at the height of one of the apexes of protrusions 27 protruding from the stop side 23′.

All of the disclosed features (alone but also in combination with one another) are essential for the invention. The disclosure content of the corresponding/enclosed priority documents (copy of the prior application) is herewith also included in its entirety in the disclosure of the application, also for the purpose of adding features of these documents into claims of the present application. With their features, the subclaims characterize, even without the features of a referenced claim, separate inventive further developments of the prior art, in particular in order to file divisional applications on the basis of these claims. The invention specified in each claim can additionally have one or several of the features, which are in particular provided with reference numerals in the above description and/or which are specified in the list of reference numerals. The invention also relates to designs, in the case of which individual features of the features mentioned in the above description are not realized, in particular insofar as they are evidently dispensable for the respective intended purpose or can be replaced by other technically equivalent means.

### LIST OF REFERENCE NUMERALS

1 marking tool 21 restraining protrusion
2 cut-out 22 indentation
3 contact flank 22′ bottom edge
4 point of intersection 23 contact strip
5 workpiece 23′ stop side
5′ front side 24 stop edge
5″ jacket surface 25 second angle scale
6 bottom 26 openings
7 window 26′ openings
7′ marking edge 27 rib
8 joint 28 longitudinal slit
8′ joint roller 29 zero line
9 partial triangle 30 center point opening
9′ partial triangle 31 pencil
10 first broadside surface 32 workpiece
10′ first broadside surface 32′ surface
11 hypotenuse side 32″ surface
12 cathetus side
13 spacer element
14 recess
15 yoke
16 string
17 plumb body, winding body
18 second broadside surface
18′ second broadside surface
19 first angle scale
20 restraining opening

1. A marking tool (1) formed as marking triangle, comprising a broadside surface having a cut-out (2), wherein a rim of of the cutout defines two lines intersecting in a point of intersection (4) and forms contact flanks (3) configured for contacting a circumferential rim of a workpiece (5) adjoining a front surface of the workpiece, wherein a bottom (6) of the cut-out (2) has a window (7), which forms a marking edge (7′) running through an axis of symmetry of the contact flanks (3), along which a center line can be marked on the front surface of the workpiece (5) from another broadside surface.

2. The marking tool according to claim 1, wherein the surface of the marking triangle is divided by a joint (8) into at least two partial triangles (9, 9′), which are configured to be pivoted from a juxtaposition, in which the partial triangles (9, 9′) lie in a common plane, into an overlapped position, in which first broadside surfaces (10, 10′) of the two partial triangles (9, 9′) lie on top of one another, wherein the cut-out (2) is formed by one of the partial triangles (9, 9′) and the bottom (6) of the cut-out (2) as well as the marking edge (7′) are formed by another one of the partial triangles (9, 9′).

3. The marking tool according to claim 2, wherein the two partial triangles (9, 9′), which can be pivoted one on top of the other, are identically designed right-angled triangles, which, in the juxtaposition, form a triangle with two cathetus sides (12) of equal lengths, a hypotenuse side (11) and a joint (8), which runs perpendicular to the hypotenuse side (11) and through a point of intersection, of a straight line defined by the two cathetus sides (12).

4. The marking tool according to claim 1, wherein the contact flanks (3) run in a straight line and/or wherein the window (7) has an elongated shape and forms the marking edge (7′) with a straight-lined outer edge.

5. A marking tool formed as marking triangle comprising two cathetus sides (12) of equal lengths, a hypotenuse side (11) and a joint (8), which runs perpendicular to the hypotenuse side (11) and through a point of intersection of the straight line defined by the two cathetus sides (12), and which divides the surface of the marking triangle into at least two partial triangles (9, 9′) of equal size, which are configured to be pivoted from a juxtaposition, in which the partial triangles lie in a common plane, into an overlapped position, in which a first broadside surfaces (10, 10′) of the two partial triangles (9, 9′) lie on top of one another, wherein a region of a joint roller (8′) formed by the joint (8) protrudes from a first broadside surface (10, 10′), wherein spacer elements (13) of the first broadside surface of one of the partial triangles, which, in the overlapped position, dip into cut-outs (14) of the first broadside surface of the respective other partial triangle (9, 9′), protrude from the first broadside surface (10, 10′) of each of the two partial triangles (9, 9′).

6. The marking tool according to claim 5, wherein the spacer elements (13) have a circular or elongated layout, and a surface extension of the cut-outs (14) correspond to the layout shape of the spacer elements (13).

7. The marking tool according to claim 5, wherein a height of the spacer elements (13) and a depth of the cut-out (14) is smaller than the material thickness of the partial triangle (9, 9′).

8. The marking tool according to claim 5, wherein a dimension by which the spacer elements (13) protrude from the broadside surface (10, 10′) is smaller than the dimension by which the joint roller (8′) protrudes from the broadside surface (10, 10′) or wherein the dimensions are identical.

9. A multi-edge marking tool comprising at least one yoke (15), over which a string (16) of a plumb bob can be placed, and around which a first angle scale (19) applied to a broadside surface (18, 18′) of the marking tool is centered, further comprising a receiving means configured for receiving a plumb body (17) of the plumb bob.

10. The marking tool according to claim 9, wherein the broadside surface of the marking tool is the surface of a right-angled, isosceles triangle with a hypotenuse and an opposite corner, and the yoke (15) is formed by a notch in a region of the corner lying opposite the hypothenuse.

11. The marking tool according to claim 9, wherein the broadside surface (18) has a cut-out (2), which is configured to accommodate a winding or plumb body (17), which is formed as flat body, of a plumb bob, wherein a material thickness of the winding or plumb body (17) approximately corresponds to a depth of the cut-out (2).

12. The marking tool according to claim 11, wherein the broadside surface (18, 18′) is formed by a partial triangle 9′ of a marking triangle 1, in which two partial triangles (9, 9′) of equal size are configured to be pivoted from a juxtaposition, in which the two partial triangles lie in a common plane, into an overlapped position, in first broadside surfaces (10, 10′) of the two partial triangles lie on top of one another, wherein one of the two partial triangles (9, 9′) forms the yoke (15) and the first angle scale (19), and an opening in particular of the other partial triangle (9, 9′) forms the cut-out (2) receiving the plumb body (17).

13. The marking tool according to claim 11, wherein the plumb body (17) is held on a bottom of a depression formed by the cut-out (2) by means of at least one fixing protrusion (21) engaging with a fixing opening (20).

14. The marking tool according to claim 11, wherein a bottom of the cut-out (2) has one or several fixing openings (20), with which a fixing protrusion (21) of the plumb body (17) engages.

15. The marking tool according to claim 11, wherein the plumb body (17) has two indentations (22) lying opposite one another and a region between bottom edges (22′) of the indentations (22) has a reduced material thickness, so that the string (16) of the plumb bob can be wound up around the bottom edges (22′).

16. The marking tool according to claim 2, wherein at least one outer edge of a partial triangle (9′), exactly one outer edge of the partial triangle (9′) or an outer edge of the partial triangle (9′) belonging to the hypotenuse side (11) has a stop side (23) protruding beyond the broadside surface (18) with a stop side (23′) extending transversely to the broadside surface (18), wherein an edge (24), which faces the joint (8), of the stop side (23) protruding beyond one of the broadside surfaces (18) is a center of a second angle scale (25).

17. The marking tool according to claim 16, wherein the stop side (23′) forms a zero line (29) for a plurality of openings (26), which are arranged in the broadside and which can be used as marking gauge.

18. The marking tool according to claim 16, wherein a partial triangle (9) forming the stop side (23) adjacent partial triangle (9′) form longitudinal slits (28) running along an outer edge, which each have an outer edge, wherein the outer edge or a center line running between two outer edges can be aligned with a zero line (29) defined by the stop side (23′).

19. The marking tool according to claim 1, further comprising a center point opening (30), from which a plurality of radial distance openings (26) are in each case spaced apart by a multiple of a basic value, so that the marking tool can be used as compass.

20. The marking tool according to claim 19, wherein the center point opening (30) is provided in a region of a stop side (23′) of a stop strip (23) and lies at a height of apexes of protrusions (27) protruding from the stop side (23′).

21. (canceled)
